(19) United States
(12) Patent Application Publication
(10) Pub. No.: US 2024/0031415 A1
(43) Pub. Date: Jan. 25, 2024

(54) LOCATING RECIPIENT

(71) Applicant: Nokia Technologies Oy, Espoo (FI)

(72) Inventors: Juha Matias KALLIO, Vantaa (FI); Attila MOLNÁR, Göd (HU)

(21) Appl. No.: 18/257,358

(22) PCT Filed: Dec. 15, 2021
(86) PCT No.: PCT/IB2021/061788

§ 371 Date: Jun. 14, 2023

(30) Foreign Application Priority Data
Dec. 18, 2020 (FI) 20206344

(51) Int. Cl. H04L 65/1073; H04L 65/1016; H04W 8/06; H04W 8/04

(52) U.S. Cl. CPC H04L 65/1073; H04L 65/1016; H04W 8/06; H04W 8/04

(57) ABSTRACT

A solution for locating a recipient is disclosed. A network initiated Unstructured Supplementary Service Data, USSD, request addressed to a terminal device is received (300). Based on the Unstructured Supplementary Service Data request, a query is transmitted (306) regarding the location of the terminal device to a Home Location Register or to a Home Subscriber Server. As a response to the query, address of the Visitor Location Register serving the terminal device is received (308). The Unstructured Supplementary Service Data request is transmitted (310) to the Visitor Location Register to be forwarded to the terminal device.

### FIELD

The exemplary and non-limiting embodiments of the invention relate generally to wireless communication systems. Embodiments of the invention relate especially to apparatuses and methods in wireless communication networks.

### BACKGROUND

Unstructured Supplementary Service Data, USSD, is protocol that is used in wireless communication networks to send text-based messages communicating parties. In USSD, a real-time connection is created between communicating parties. Thus, in that aspect it is different from Short Message Service, SMS. Thus, to be able to convey USSD messages, the network must establish a connection between communicating parties.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there are provided apparatus of claim 1.

According to another aspect of the present invention, there is provided a method of claim 7.

According to another aspect of the present invention, there is provided a computer program of claim 12.

One or more examples of implementations are set forth in more detail in the accompanying drawings and the description below. Other features will be apparent from the description and drawings, and from the claims. The embodiments and/or examples and features, if any, described in this specification that do not fall under the scope of the independent claims are to be interpreted as examples useful for understanding various embodiments of the invention.

### LIST OF DRAWINGS

Embodiments of the present invention are described below, by way of example only, with reference to the accompanying drawings, in which

FIGS. 1 and 2 illustrate examples of simplified system architecture of a communication system;

FIG. 3 is a flowchart illustrating an embodiment;

FIG. 4 is a signalling chart illustrating an embodiment; and

FIG. 5 illustrates a simplified example of an apparatus applying some embodiments of the invention.

### DESCRIPTION OF SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain features, structures, units, modules etc. that have not been specifically mentioned.

Some embodiments of the present invention are applicable to a user terminal, a communication device, a base station, eNodeB, gNodeB, a distributed realisation of a base station, a network element of a communication system, a corresponding component, and/or to any communication system or any combination of different communication systems that support required functionality.

The protocols used, the specifications of communication systems, servers and user equipment, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. The embodiments may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

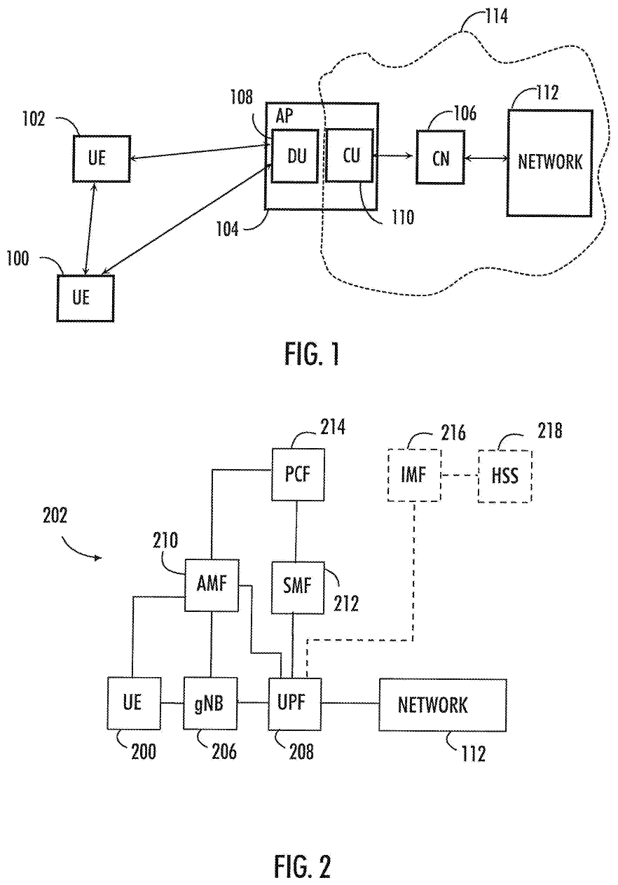

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows devices 100 and 102. The devices 100 and 102 are configured to be in a wireless connection on one or more communication channels with a node 104. The node 104 is further connected to a core network 106. In one example, the node 104 may be an access node such as (e/g)NodeB serving devices in a cell. In one example, the node 104 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 106 (CN or next generation core NGC). Depending on the deployed technology, the (e/g)NodeB is connected to a serving and packet data network gateway (S-GW+P-GW) or user plane function (UPF), for routing and forwarding user data packets and for providing connectivity of devices to one ore more external packet data networks, and to a mobile management entity (MME) or access mobility management function (AMF), for controlling access and mobility of the devices.

Exemplary embodiments of a device are a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or in some embodiments a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input—multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, e.g. below 6 GHz or above 24 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, 6 or above 24 GHz-cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 112, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

The technology of Edge cloud may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 108) and non-real time functions being carried out in a centralized manner (in a centralized unit, CU 110).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or NodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g)NodeBs, the device may have an access to a plurality of radio cells and the system may comprise also other apparatuses, such as physical layer relay nodes or other network elements, etc. At least one of the (e/g)NodeBs or may be a Home(e/g)NodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

FIG. 2 illustrates an example of a communication system based on 5G network components. A user terminal or user equipment 200 communicating via a 5G network 202 with a data network 112. The user terminal 200 is connected to a Radio Access Network RAN node, such as (e/g)NodeB 206 which provides the user terminal with a connection to the network 112 via one or more User Plane Functions, UPF 208. The user terminal 200 is further connected to Core Access and Mobility Management Function, AMF 210, which is responsible for handling connection and mobility management tasks and can be seen from this perspective as the 5G version of Mobility Management Entity, MME, in LTE. The 5G network further comprises Session Management Function, SMF 212, which is responsible for subscriber sessions, such as session establishment, modify and release, and a Policy Control Function, PCF 214 which is configured to govern network behavior by providing policy rules to control plane functions.

Connected to the 5G network 202 is the Internet Protocol Multimedia Subsystem, IMS 216. IMS 216 is an architectural framework for delivering multimedia communications services such as voice, video and text messaging over IP networks. IMS was developed by the 3rd Generation Partnership Project, 3GPP. Session Initiation Protocol, SIP, has been developed to be used in interactive communication sessions such as voice, video and chat, for example. It has been included as an element IMS architecture for IP-based streaming multimedia services. 3GPP has standardised transfer of Unstructured Supplementary Service Data (USSD) information over the SIP in IMS architecture. It has been defined how networks entities such as terminal devices and so called Unstructured Supplementary Service Data over IM Core Network subsystem Application Server, USSI AS, handle USSD information as SIP payload. USSI AS can be realised as network function and it can be co-located in a Telephony Application Server, TAS, for example. IMS comprises a Home Subscriber Server 218, which stores subscription-related information.

Two procedures for USSD have been defined by 3GPP, namely user initiated and network-initiated procedures. In former procedure it is the terminal device that originates USSD dialogue towards the network which can be used in order to exchange USSD payload back and forth between the terminal device and USSD application in network. In latter case the network initiates the USSD dialogue towards the terminal device.

The 3GPP has defined IMS related methods and message format how USSD payload is transferred within the IMS architecture. However, an end to end solution for the delivery of USSD information between a terminal device and serving application, especially in case of network initiated USSD request is not defined. In case of network initiated USSD request, one problem is related to functionality how USSI AS can complete the delivery of network initiated USSD request to a correct access domain of recipient based on the IMS registration state of recipient. If the recipient is not registered or reachable in IMS, but is reachable only via Circuit Switched, CS, domain, the USSI AS is currently unable to deliver the USSD request.

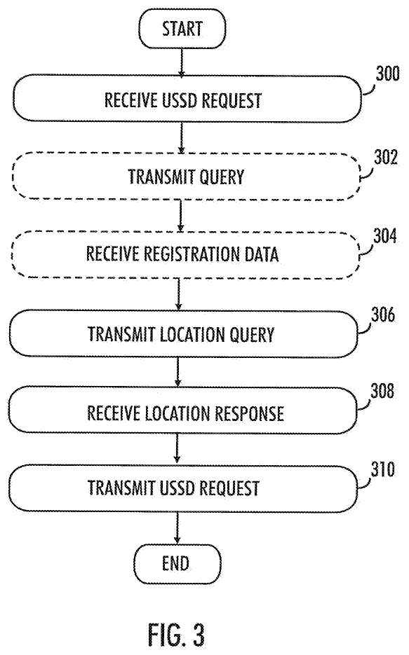

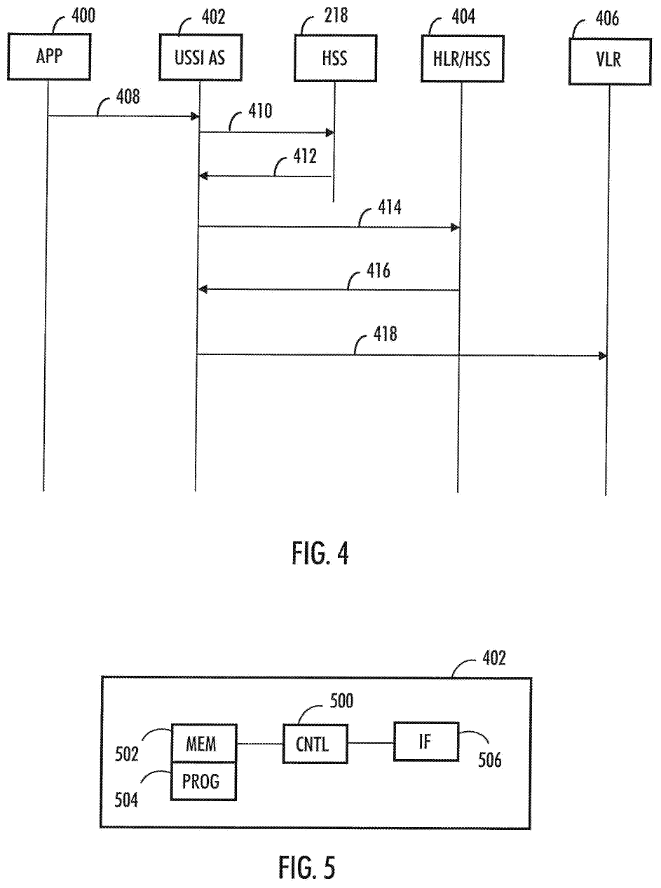

The flowchart of FIG. 3 illustrates an embodiment. The flowchart illustrates an example of the operation of an apparatus. In an embodiment, the apparatus may be a network element or a part of a network element performing as an Unstructured Supplementary Service Data over IM Core Network subsystem Application Server, USSI AS. FIG. 4 is a corresponding signalling chart.

In step 300, the network element 402 is configured to receive a network initiated Unstructured Supplementary Service Data, USSD, request 408 addressed to a terminal device.

When an USSD application (such as an Unstructured Supplementary Service Data Center, USSDC, or an external application server, for example) wishes to transmit a network initiated USSD request to a terminal device that supports USSI, then the USSD application is configured to transmit the USSD request by using a suitable Mobile Application Part, MAP, request message as defined in 3GPP TS 29.002 to the network element that acts as the USSI AS.

In an optional step 302, the network element is configured to transmit a query 410 to a Home Subscriber Server, HSS, of the communication network whether the terminal device is registered to Internet Protocol Multimedia Subsystem, IMS.

In an embodiment, the USSI AS which receives the USSD request from the USSD application is configured to at first perform a check whether the terminal device indicated as the recipient of the USSD request is registered to IMS. In an embodiment, this may be done by transmitting an Sh query by sending a User Data Request, UDR, request to HSS with IMS User State request.

In an optional step 304, the network element is configured to receive, as a response to the query, information 412 that the terminal device is not registered to Internet Protocol Multimedia Subsystem.

In an embodiment, instead of steps 302, 304, the USSI AS may try to deliver the USSI content to a terminal device, which delivery may fail for reason or another. The attempt failure triggers USSI AS to re-try delivery via Circuit Switched, CS, domain.

In an embodiment, as a response to the request, the HSS is configured to provide information related to state of IMS registration (REGISTERED/NOT_REGISTERED) of the terminal device, which then is used by USSI AS in way described below. Alternatively, in case the terminal device is not an IMS user, the HSS may respond with Sh UDA error (user not found/unknown) to USSI-AS, meaning the Sh query for subscriber identity fails resulting terminating access domain selection to CS domain. This applies especially when the above steps 302, 304 have been performed.

Further, in an embodiment after the steps 302, 304, if the terminal device is registered to IMS but the delivery of USSI content to the terminal device fails, the USSI AS is configured to decide that the USSD request shall be attempted to be delivered via Circuit Switched, CS, domain.

In the case the terminal device designated as the recipient of the USSD request is not IMS registered or non IMS user, the USSI AS is configured to decide that the USSD request shall be attempted to be delivered via Circuit Switched, CS, domain.

In step 306, the network element is configured to transmit, based on the Unstructured Supplementary Service Data request, a query 414 regarding the location of the terminal device to a Home Location Register, HLR, or to a Home Subscriber Server, HSS, of the communication network.

In step 308, the network element is configured to receive, as a response to the query, the address 416 of the Visitor Location Register serving the terminal device; In step 310, the network element is configured to transmit the Unstructured Supplementary Service Data request 418 to the Visitor Location Register to be forwarded to the terminal device.

In an embodiment, the network element is configured to transmit the query 414 of step 306 regarding the location of the terminal device as a MAP message MAP-SEND-ROUTING-INFO-FOR-LCS request to HLR. LCS denotes Location Service Feature.

In an embodiment, the network element is configured to transmit the query 414 of step 306 regarding the location of the terminal device as a MAP message MAP-ANY-TIME-INTERROGATION request to HLR.

In an embodiment, the network element is configured to transmit the query 414 of step 306 regarding the location of the terminal device as a a User Data Request, UDR, request to HSS with a LocationInformation request.

As result of these procedures, the HLR or HSS return currently serving VLR address of the terminal device to USSI AS.

The network element is configured then to use this address and try to deliver the network initiated USSD request towards the VLR by forwarding or sending a MAP request (MAP-PROCESS-SS-REQUEST) to VLR.

FIG. 5 illustrates an embodiment. The figure illustrates a simplified example of an apparatus applying embodiments of the invention. It should be understood that the apparatus is depicted herein as examples illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities. In some embodiments, the apparatus may be a network element or a part of a network element performing as an Unstructured Supplementary Service Data over IM Core Network subsystem Application Server, USSI AS.

The apparatus 402 of the example includes a control circuitry 500 configured to control at least part of the operation of the apparatus.

The apparatus may comprise a memory 502 for storing data. Furthermore, the memory may store software 504 executable by the control circuitry 500. The memory may be integrated in the control circuitry.

The apparatus may comprise one or more interface circuitries 506. The interface circuitries are operationally connected to the control circuitry 500. The interface 506 may connect the apparatus to other apparatuses of a communication system, for example.

In an embodiment, the software 506 may comprise a computer program comprising program code means adapted to cause the control circuitry 500 of the apparatus to realise at least some of the embodiments described above.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst several computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

In an embodiment, an apparatus comprises means for receiving a network initiated Unstructured Supplementary Service Data, USSD, request addressed to a terminal device; means for transmitting, based on the Unstructured Supplementary Service Data request, a query regarding the location of the terminal device to a Home Location Register or to a Home Subscriber Server; means for receiving, as a response to the query, address of the Visitor Location Register serving the terminal device and means for transmitting the Unstructured Supplementary Service Data request to the Visitor Location Register to be forwarded to the terminal device.

It will be obvious to a person skilled in the art that, as the technology advances, the inventive concept can be implemented in various ways. The invention and its embodiments are not limited to the examples described above but may vary within the scope of the claims.

1-12. (canceled)

13. A network element in a communication network, comprising at least one processor; and at least one memory including computer program code, the at least one memory and computer program code configured to, with the at least one processor, cause the network element to:
receive a network initiated Unstructured Supplementary Service Data, USSD, request addressed to a terminal device;
transmit, based on the Unstructured Supplementary Service Data request, a query regarding the location of the terminal device to a Home Location Register or to a Home Subscriber Server;
receive, as a response to the query, address of the Visitor Location Register serving the terminal device;
transmit the Unstructured Supplementary Service Data request to the Visitor Location Register to be forwarded to the terminal device.

14. The network element of claim 13, wherein the at least one memory and computer program code configured to, with the at least one processor, cause the network element further to:
query from a Home Subscriber Server whether the terminal device is registered to Internet Protocol Multimedia Subsystem, IMS,
receive, as a response to the query, information that the terminal device is not registered to Internet Protocol Multimedia Subsystem, or the terminal device is not an Internet Protocol Multimedia Subsystem user or terminal device is registered to Internet Protocol Multimedia Subsystem but Unstructured Supplementary Service Data over IM Core Network delivery fails.

15. The network element of claim 13, wherein query regarding the location of the terminal device is a MAP-SEND-ROUTING-INFO-FOR-LCS request to Home Location Register, HLR.

16. The network element of claim 13, wherein query regarding the location of the terminal device is a MAP-ANY-TIME-INTERROGATION request to Home Location Register, HLR

17. The network element of claim 13, wherein query regarding the location of the terminal device is a User Data Request, UDR, request to a Home Subscriber Server, HSS, with a LocationInformation request.

18. The network element of claim 13, wherein the network element is an Unstructured Supplementary Service Data over IM Core Network subsystem Application Server.

19. A method in a network element, comprising:
receiving a network initiated Unstructured Supplementary Service Data, USSD, request addressed to a terminal device;
transmitting, based on the Unstructured Supplementary Service Data request, a query regarding the location of the terminal device to a Home Location Register or to a Home Subscriber Server;
receiving, as a response to the query, address of the Visitor Location Register serving the terminal device;
transmitting the Unstructured Supplementary Service Data request to the Visitor Location Register to be forwarded to the terminal device.

20. The method of claim 19, wherein further comprising:
querying from a Home Subscriber Server whether the terminal device is registered to Internet Protocol Multimedia Subsystem, IMS,
receiving, as a response to the query, information that the terminal device is not registered to Internet Protocol Multimedia Subsystem, or the terminal device is not an Internet Protocol Multimedia Subsystem user or terminal device is registered to Internet Protocol Multimedia Subsystem but Unstructured Supplementary Service Data over IM Core Network delivery fails.

21. The method of claim 19, wherein query regarding the location of the terminal device is a MAP-SEND-ROUTING-INFO-FOR-LCS request to Home Location Register, HLR.

22. The method of claim 19, wherein query regarding the location of the terminal device is a MAP-ANY-TIME-INTERROGATION request to Home Location Register, HLR

23. The method of claim 19, wherein query regarding the location of the terminal device is a User Data Request, UDR, request to a Home Subscriber Server, HSS, with a LocationInformation request.

24. A computer program comprising instructions for causing an apparatus at least to:
receive a network initiated Unstructured Supplementary Service Data, USSD, request addressed to a terminal device;
transmit, based on the Unstructured Supplementary Service Data request, a query regarding the location of the terminal device to a Home Location Register or to a Home Subscriber Server;
receive, as a response to the query, address of the Visitor Location Register serving the terminal device;
transmit the Unstructured Supplementary Service Data request to the Visitor Location Register to be forwarded to the terminal device.
